(19) United States
(12) Patent Application Publication
(10) Pub. No.: US 2023/0288774 A1
(43) Pub. Date: Sep. 14, 2023

(54) Narrow Linewidth, Widely Tunable Integrated Lasers from Visible to Near-IR

(71) Applicant: The Trustees of Columbia University in the City of New York, New York, NY (US)

(72) Inventors: Mateus Corato Zanarella, New York, NY (US); Andres Gil Molina, New York, NY (US); Xingchen Ji, New York, NY (US); Min Chul Shin, New York, NY (US); Aseema Mohanty, New York, NY (US); Michal Lipson, New York, NY (US)

(21) Appl. No.: 18/052,377

(22) Filed: Nov. 3, 2022

Related U.S. Application Data
(60) Provisional application No. 63/275,141, filed on Nov. 3, 2021.

(51) Int. Cl. G02F 1/225

(52) U.S. Cl. CPC G02F 1/225; G02F 2203/15; G02F 2201/06

(57) ABSTRACT

Methods, systems, and devices for light emission are disclosed. An example device may comprise an optical source configured to output light, a waveguide optically coupled to the optical source and configured to carry the light, and a feedback portion configured to reflect the light back to the optical source via the waveguide. The feedback portion may comprise a microresonator optically coupled to the waveguide. The device may comprise one or more tuning elements configured to tune one or more of the microresonator or the waveguide to cause constructive interference between the reflected light and light of the optical source, resulting in optical emission of both the reflected light and the light of the optical source from an end of the waveguide.

### CROSS-REFERENCE TO RELATED APPLICATIONS

This application is related to U.S. Patent Application No. 63/275,141 filed Nov. 3, 2021, which is hereby incorporated by reference for any and all purposes.

### GOVERNMENT SUPPORT

This invention was made with government support under Grant No. W911NF-21-1-0286 awarded by the U.S. Army/Army Research Office. The government has certain rights in the invention.

### BACKGROUND

Integrated, tunable and narrow linewidth light sources spanning the entire visible spectrum range are essential to enable chip-scale applications such as ion trapping, quantum photonics, biosensors, AR/VR, neural probes, nonlinear photonics and spectroscopy. To date, light sources with all these properties have not been realized, since the wavelength sensitivity of most optical components makes it fundamentally challenging to cover the whole visible spectral range in an integrated platform. Typical visible wavelength lasers are still bulky, expensive and heavily rely on external free-space cavities and components. Recent efforts have been made to develop narrow linewidth and tunable light sources in the visible and near-visible range based on microtoroids. However, these efforts also rely on external free-space components, have little tunability, require bulky piezoelectric actuators and/or thermoelectric cooler elements for tuning, are not fully integrated, and have been currently only shown to work at near-IR and blue wavelengths. Integration of photonic chips to III-V reflective semiconductor optical amplifiers (RSOAs) has also been shown to generate narrow-linewidth and tunable lasing, but only limited to the red spectral range, low injection current and with large footprint. Moreover, hybrid integration of RSOAs requires very low coupling loss and very little undesired reflection for stable lasing, which increases the complexity of the system and demands high accuracy alignment and complex packaging. In these types of RSOA-based platforms, power and wavelength scalability are limited. Thus, there is a need for high-performance integrated light sources.

### SUMMARY

Methods, systems, and devices for light emission are disclosed. An example device may comprise an optical source configured to output light, a waveguide optically coupled to the optical source and configured to carry the light, and a feedback portion configured to reflect the light back to the optical source via the waveguide. The feedback portion may comprise a microresonator (e.g., or resonator, microring) optically coupled to the waveguide. The device may comprise one or more tuning elements configured to tune one or more of the microresonator or the waveguide to cause constructive interference between the reflected light and light of the optical source, resulting in optical emission of both the reflected light and the light of the optical source from an end of the waveguide.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

Additional advantages will be set forth in part in the description which follows or may be learned by practice. It is to be understood that both the foregoing general description and the following detailed description are exemplary and explanatory only and are not restrictive.

### BRIEF DESCRIPTION OF THE DRAWINGS

The file of this patent or application contains at least one drawing/photograph executed in color. Copies of this patent or patent application publication with color drawing(s)/photograph(s) will be provided by the Office upon request and payment of the necessary fee.

The accompanying drawings, which are incorporated in and constitute a part of this specification, illustrate embodiments and together with the description, serve to explain the principles of the methods and systems.

FIG. 1A shows a schematic of an example device in accordance with the present disclosure.

FIG. 1B shows a graph illustrating ring resonance of an example device.

FIG. 1C shows an image of an example device.

FIG. 1D shows a comparison of an unlocked device (top) and a locked device.

FIG. 2 shows graphs illustrating coarse tuning (top row) and frequency pulling (fine tuning) (bottom row) of self-injection locked devices spanning from visible to near-IR.

FIG. 3A is a graph illustrating frequency noise of an example self-injection locked device.

FIG. 3B is a graph illustrating lineshape of an example self-injection locked device at 786.62 nm measured with a linewidth analyzer (Toptica LWA-1k 780).

FIG. 3C shows lineshape of the self-injection locked laser at −488 nm measured by beating the integrated laser with a commercial narrow linewidth laser (Toptica DL Pro 488 nm).

FIG. 4 shows multiple lasers of different colors on the same optical chip.

FIG. 5 is a plot showing how the relative output power of the laser (output power of the chip divided by the power emitted by the light source before the chip) changes with coupling loss.

FIG. 6 shows an example resonator-based feedback loop.

FIG. 7 is a block diagram illustrating an example computing device for controlling a device and/or system as disclosed herein.

### DETAILED DESCRIPTION OF ILLUSTRATIVE EMBODIMENTS

Disclosed herein are devices for light emission. An example device in accordance with the present disclosure may comprise a chip-scale laser platform. The device may be designed for lasing with narrow linewidth and tunability over a large spectral range, such as the whole visible spectrum up to near-IR. The disclosed devices may be based on high confinement, high quality factor (Q) silicon nitride (Si₃N₄) resonators and commercially available Fabry-Perot (FP) laser diodes. The large transparency window of Si₃N₄ may be leveraged by the disclosed devices for high confinement low-loss light propagation at visible wavelengths. FP laser diodes for self-injection locking integrated into the disclosed devices may be robust against coupling loss and undesired reflections. Analysis of the disclosed devices show that by coupling laser diodes to a low-loss ring resonator with an optical feedback path at its drop port, self-injection locking may cause the collapse of the multiple longitudinal modes of the diode into a single longitudinal mode (e.g., with further linewidth reduction induced by the high Q of the resonator). The disclosed device may achieve lasing at different wavelengths by tuning the resonator's resonance to align to different longitudinal modes of the device (e.g., laser).

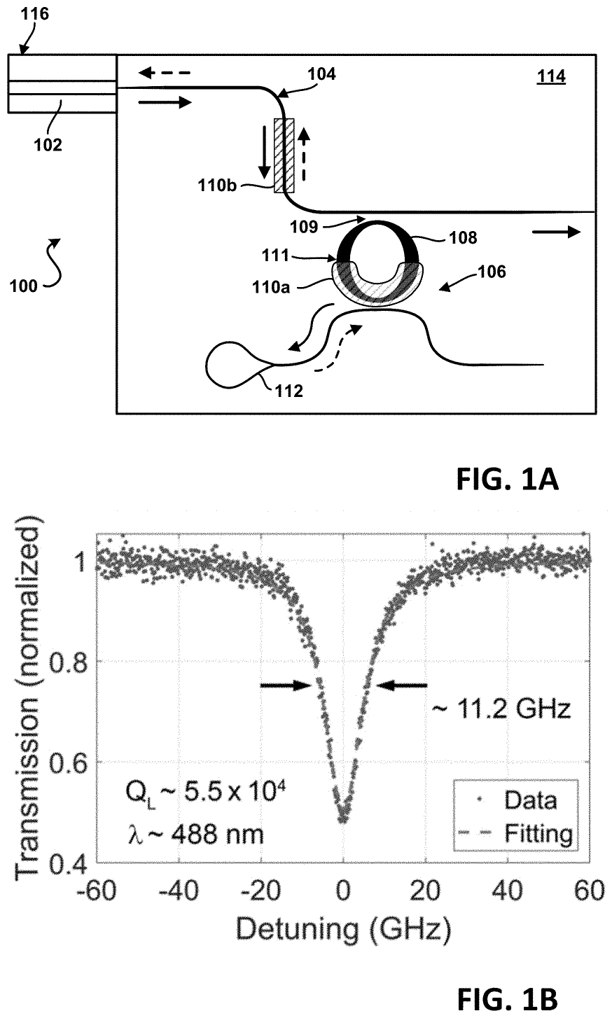

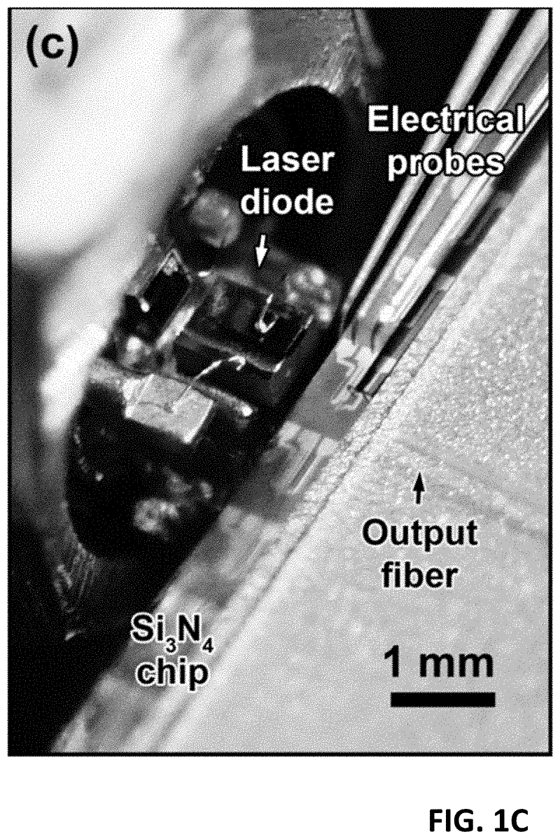

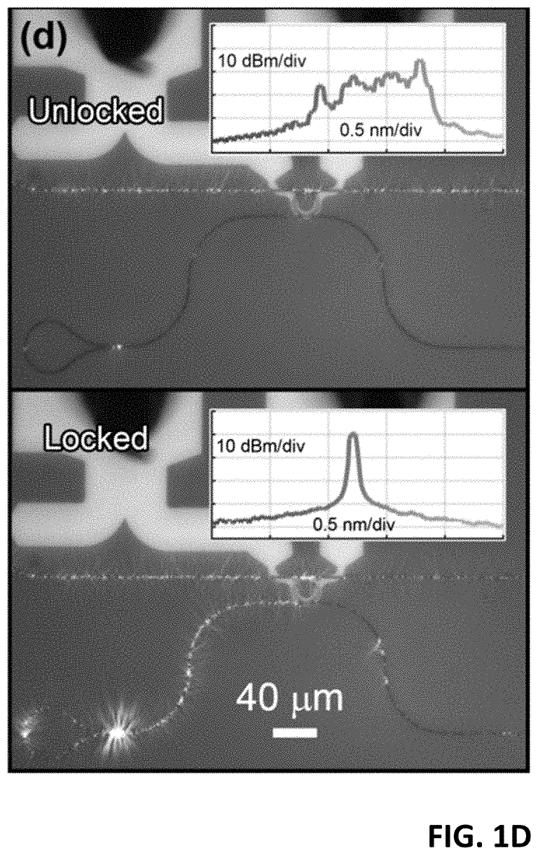

FIG. 1A shows a schematic of an example device 100 in accordance with the present disclosure. The device 100 may comprise an integrated laser. A Fabry-Perot (FP) laser diode may be edge-coupled to an integrated chip. A ring resonator with a feedback loop at the drop port may act as a wavelength selective reflector.

The device 100 may comprise an optical source 102 configured to output light. The light output by the optical source 102 and its path is shown using large solid arrows in FIG. 1. The optical source 102 may comprise a laser, a diode, a gain medium, and/or the like. The optical source 102 may comprise a Fabry-Perot laser diode. The optical source 102 may emit laser light. The optical source 102 may be configured to output one or more of visible light, near infrared light, light in the range of about 400 nm to about 800 nm, or any combination thereof.

The device 100 may comprise a waveguide 104. The waveguide 104 may be optically coupled to the optical source 102 and configured to carry the light. The waveguide 104 may comprise silicon nitride, lithium niobate, aluminum nitride, aluminum oxide, titanium oxide, magnesium fluoride, a combination thereof, and/or the like.

The device 100 may comprise a feedback portion 106. The feedback portion 106 may be configured to reflect the light back to the optical source 102 via the waveguide 104. The reflected light is shown using dashed arrows in FIG. 1. The feedback portion 106 may comprise a microresonator 108. The microresonator 108 may comprise a ring resonator. The microresonator 108 may be optically coupled to the waveguide 104. The feedback portion 106 (e.g., the microresonator 108) may comprise silicon nitride, lithium niobate, aluminum nitride, aluminum oxide, titanium oxide, magnesium fluoride, a combination thereof, and/or the like.

The microresonator 108 may have a cross-sectional width that tapers along a circumference of microresonator 108 such that a width of the microresonator 108 is narrower at a coupling region 109 of the microresonator 108 and the waveguide 104 than at a mid-point 111 of the microresonator 108. The microresonator 108 may have a first cross-sectional width at a coupling region 109 of the microresonator 108 and the waveguide 104 and a second cross-sectional width at a mid-point 111 of the microresonator 108. The first cross-sectional width may only a single mode of light and the second cross-sectional width may have a decreased scattering loss in comparison the first cross-sectional width.

The device 100 may comprise one or more tuning elements 110. The one or more tuning elements 110 may be configured to tune one or more of the microresonator 108 or the waveguide 104. The one or more tuning elements 110 may be configured to tune one or more of the microresonator 108 or the waveguide 104 to cause constructive interference between the reflected light and light of the optical source 102 (e.g., resulting in optical emission of both the reflected light and the light of the optical source from an end of the waveguide).

The one or more tuning elements 110a,b may comprise a first tuning element 110a disposed on at least a portion of the microresonator 108. The first tuning element 110a may be configured to tune the microresonator 108 to align its resonance to a wavelength of the optical source 102. The one or more tuning elements 110a,b may comprise a second tuning element 110b. The second tuning element 110b may be disposed on at least a portion of the waveguide 104 between the optical source 102 and the microresonator 108 (e.g., and the feedback portion 106). The second tuning element 110b may be configured to adjust a phase of the reflected light to interfere constructively with the light of the optical source 102. The one or more tuning elements 110a,b may comprise one or more of electro-optic modulators (e.g., based on lithium niobate) and/or heaters.

The feedback portion 106 may comprise a feedback loop 112 optically coupled to the microresonator 108. The feedback loop 112 may be configured to receive light from the microresonator 108 and provide the reflected light back to the microresonator 108. The feedback loop 112 may comprise one or more of a multimode-interferometer or Y splitter. The feedback loop 112 may be optically coupled to a side of the microresonator 108 opposite of a side of the microresonator coupled to the waveguide. The feedback loop 112 may comprise silicon nitride, lithium niobate, aluminum nitride, aluminum oxide, titanium oxide, magnesium fluoride, a combination thereof, and/or the like.

The device 100 may comprise an integrated chip 114. The integrated chip 114 may comprise the optical source 102, the waveguide 104, the microresonator 108, the one or more tuning elements 110, or any combination thereof. The device 100 may comprise an additional chip 116. The additional chip 116 may comprise the optical source 102. The additional chip 116 may be coupled (e.g., using an inverse taper edge coupling) to the integrated chip 114. In other scenarios, the integrated chip 114 may comprise the optical source.

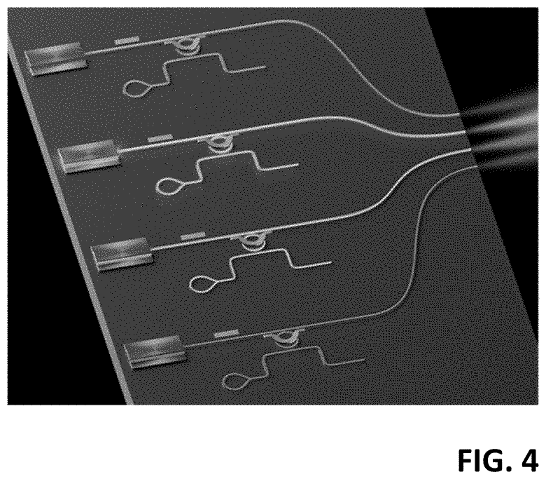

The optical source 102, the waveguide 104, the feedback portion 106, the one or more tuning elements 110, or any combination thereof may comprise a light emitting element of a plurality of light emitting elements (e.g., as shown in FIG. 4). Each of the plurality of light emitting elements may be configured to output a different wavelength of light. Each of the plurality of light emitting elements (e.g., or portions of each of the plurality of light emitting elements) may be disposed on a single integrated chip (e.g., integrated chip 114). The plurality of light emitting elements may together configure the device 100 to output light along a full range of wavelengths from about 400 nm to about 800 nm. As one example, a single integrated chip may comprise a corresponding optical source 102 (e.g., one for each of a plurality of colors and/or color ranges), a waveguide 104, a feedback portion 106, one or more tuning elements 110, or any combination thereof for each of a plurality of light emitting elements. As another example, the optical sources (e.g., one for each of a plurality of colors and/or color ranges) for each of the plurality of light emitting elements may each be on separate chips (e.g., or one separate chip) that are coupled to the same waveguide (e.g., resulting in multiple optical sources but a single waveguide and feedback portion). As another example, the optical sources (e.g., one for each of a plurality of colors and/or color ranges) for each of the plurality of light emitting elements may each be on separate chips that are coupled to different corresponding waveguides and feedback portions.

FIG. 1B shows a graph illustrating ring resonance of an example device. Ring resonance is shown by graphed data points measured with a Toptica DL Pro 488 nm laser. The loaded quality factor is 5.5×10⁴ and the extinction is ˜50%. FIG. 1C shows an image of an example device.

FIG. 1D shows a comparison of an unlocked device (top) and a locked device. Unlocked and locked blue (˜492 nm) laser, with the corresponding output spectra measured with an optical spectrum analyzer (OSA) (Ando AQ6315A). The measured linewidth of each longitudinal mode is limited by the OSA resolution (0.05 nm).

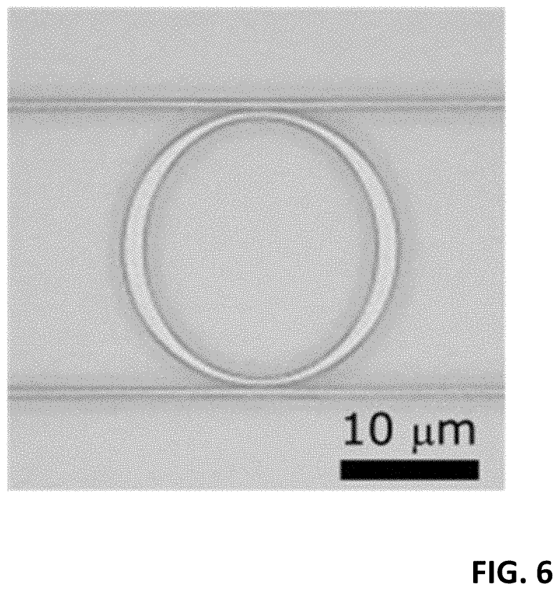

The disclosed photonic components may be designed operate across the whole visible to near-IR spectral range using a platform of 175 nm-thick Si₃N₄ waveguide core surrounded by silicon oxide (e.g., FIG. 1A). The disclosed device may comprise ring resonator with tapered dimensions from 300 nm to 1500 nm (e.g., as shown in FIG. 6) to ensure single mode operation and strong waveguide-to-ring coupling for all the wavelengths while maintaining high Q (e.g., as shown in FIG. 1B). The high confinement may be leveraged to design the resonator with a small radius (e.g., 10 μm). The resulting large free-spectral range (FSR) of several nanometers across the whole visible spectrum allows the feedback of a specific wavelength within the gain bandwidth of the laser diodes without the need for an external filter. Such frequency-selective feedback over a large range eliminates mode-hopping between longitudinal modes of the laser diodes when they are self-injection locked by our resonator. The lasing wavelength can be tuned within the FSR by tuning the resonator by a phase shifter, such as by using thermo-optic effect with a microheater or using electro-optic phase shifters (e.g., lithium niobate or aluminum nitride). The lasing wavelength may be tuned by changing the temperature and/or current of the FP laser diode (e.g., or other optical source). The lasing wavelength may be tuned by change the temperature of the optical source, the current of the optical source, by using phase shifters, or any combination thereof. The feedback loop may be optimized at the drop port of the resonator for broad bandwidth, leveraging that the self-injection locking of FP laser diodes is robust to the amount of reflection. Inverse taper edge couplers may be used to provide good laser-to-chip and chip-to-fiber coupling without inducing spurious reflections.

The disclosed techniques achieve broadband, narrow linewidth, tunable lasing by edge-coupling FP laser diodes to an integrated chip and controlling the position of the ring resonator's resonance using thermo-optic phase shifters (e.g., FIG. 1C). The phase shifters may comprise thermo-optic phase shifters, electro-optic phase shifters, and/or the like. Coarse tuning may be used to tune the lasing wavelength by tuning the resonator to different longitudinal modes of the laser diodes. When the resonator is detuned from the modes of the laser, the power dropped to the feedback loop is negligible and the laser diode lases with multiple longitudinal modes (e.g., as shown in FIG. 1D, top). When the resonator is aligned to a mode of the laser, power is dropped to the feedback loop and then reflected back to the diode. The phase of the reflected light may be adjusted to cause the self-injection locking by using the phase-shifter on the bus waveguide in between the diode and the resonator. When the laser is locked, the longitudinal modes of the laser diode collapse into a single one (e.g., FIG. 1D, bottom). Fine tuning (or frequency pulling) may be achieved by further tuning the resonator, tuning the optical source laser current, or a combination thereof around the point of self-injection locking.

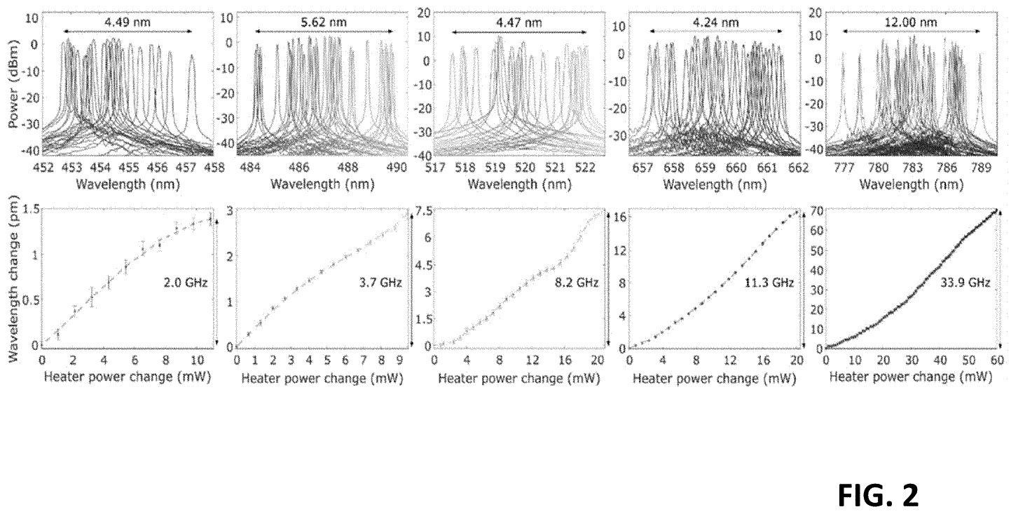

FIG. 2 shows graphs illustrating coarse tuning (top row) and frequency pulling (fine tuning) (bottom row) of self-injection locked devices spanning from visible to near-IR. The displayed linewidth of each line is limited by the OSA resolution. Narrow linewidth, widely tunable integrated lasers over a large spectral range covering the whole visible spectrum up to near-IR are shown, as examples deep blue (˜455 nm), blue (˜488 nm), green (˜520 nm), red (˜660 nm) and near-IR (˜785 nm) wavelengths with output fiber-coupled powers up to 10 mW, intrinsic linewidth<1.26 kHz, wavelength tuning up to 12 nm and side-mode suppression ratios (SMSR) up to ˜38 dB. Coarse tuning ranges/SMSRs are achieved of ˜4.49 nm/˜37 dB in deep blue, ˜5.62 nm/˜38 dB in blue, ˜4.47 nm/˜37 dB in green, ˜4.29 nm/˜35 dB in red, and ˜12 nm/˜38 dB in near-IR (e.g., FIG. 2, top row). Frequency pulling ranges are shown of 2.0 GHz in deep blue, 3.7 GHz in blue, 8.2 GHz in green, 11.3 GHz in red, 33.9 GHz in near-IR (e.g., FIG. 2, bottom row) by changing the microheater power while monitoring the lasing wavelength with a wavemeter.

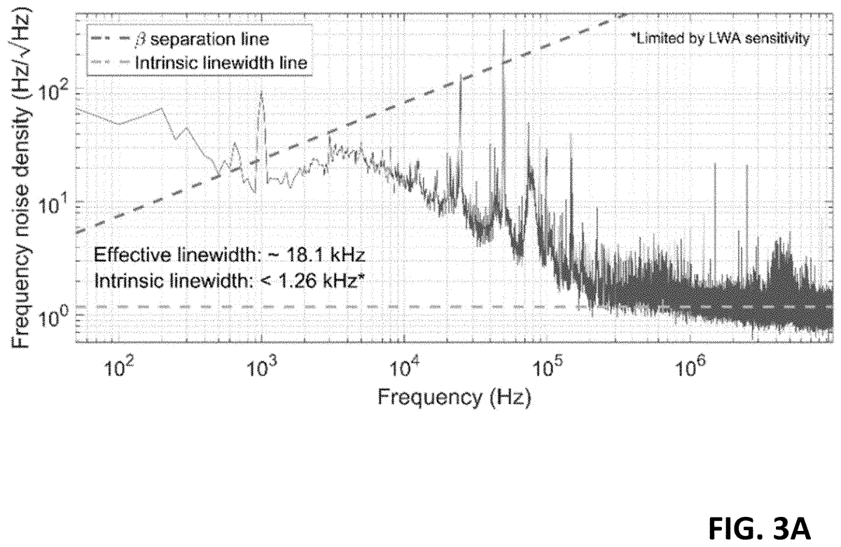

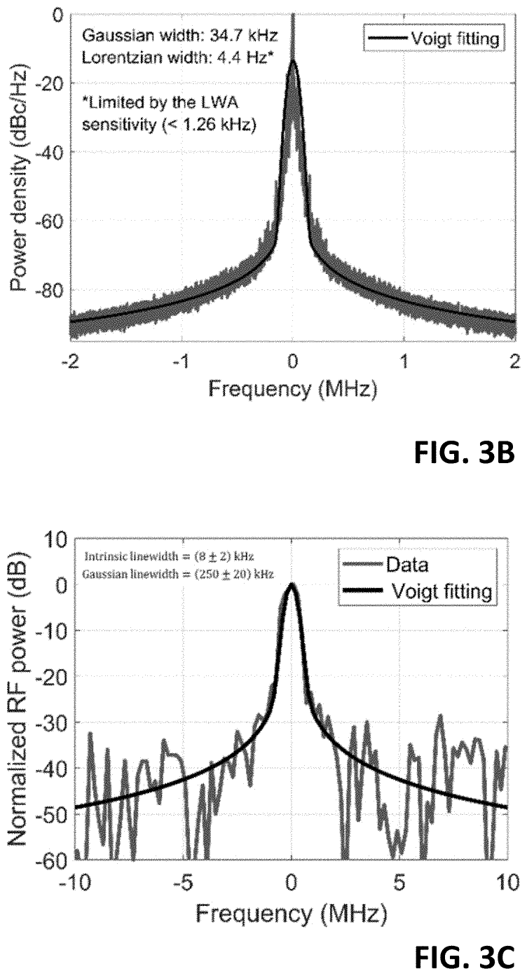

FIG. 3A is a graph illustrating frequency noise of an example self-injection locked laser. FIG. 3B is a graph illustrating lineshape of an example self-injection locked laser at 786.62 nm measured with a linewidth analyzer (Toptica LWA-1k 780). The laser noise is below the sensitivity of the analyzer, from which it may be concluded that the intrinsic linewidth is at least <1.26 kHz. FIG. 3C shows lineshape of the self-injection locked laser at −488 nm measured by beating the integrated laser with a commercial narrow linewidth laser (Toptica DL Pro 488 nm). The measurement is limited by the linewidth of the commercial laser, from which it may be concluded that the intrinsic linewidth of the integrated blue laser is at least <8 kHz.

The frequency noise and intrinsic linewidth of the self-injection locked 785 nm laser was measured using a linewidth analyzer (Toptica LWA-1k 780) (e.g., FIGS. 3A and 3B). The frequency noise is below the noise sensitivity of the instrument, from which it can be derived that the intrinsic linewidth is at least <1.26 kHz. In blue, an example integrated laser was beat with a Toptica DL Pro 488 nm laser and the RF beat note was measured using a spectrum analyzer (e.g., FIG. 3C). The Voigt fitting of its lineshape shows that the intrinsic linewidth of our integrated laser has an upper bound of about 8 kHz.

The results show that it is possible to achieve narrow linewidth and widely tunable lasers covering the whole visible to near-IR spectral range in a single chip-scale platform with linewidth, tuning range, power and SMSR comparable to bulky commercial external cavity laser systems. The disclosed devices may be a key enabler for fully integrated visible light systems for applications such as quantum photonics, AR and VR, biosensing, and spectroscopy, among others. The same idea could be used with other material platforms, such as AlN, SiO₂, lithium niobate, MgF₂ for example, to build tunable, narrow linewidth lasers at visible to near-IR wavelengths.

FIG. 4 shows multiple lasers of different colors on the same optical chip. For each of a plurality of colors, a feedback loop may be provided. Each feedback loop may be on the same chip and/or may be on separate chips. A separate laser diode (e.g., or other optical source) may be coupled to each of the feedback loops. Each laser may be coupled to the optical chip and/or may be included on the same integrated chip.

Physical Working Principle

The disclosed device may comprise a light source (e.g., Fabry-Perot laser diode) of the desired color coupled to and/or disposed on a chip. Multiple wavelengths of light may be used (e.g., by having multiple light sources coupled to a single chip and/or multiple chips).

Using the microheater on a ring resonator, the resonance of the resonator can be aligned to one of the lasing wavelengths. The resonator may drop light to a feedback loop, which is reflected back to the laser diode. A microheater may be used on a waveguide before the resonator to adjust the phase of the reflected light so that the reflected light interferes constructively with the light inside of the laser diode. This reflected light acts as an effective additional gain for that wavelength and forces all the light to collapse to that wavelength and to become narrow linewidth. By tuning the phase shifter of the ring resonator, the wavelength of the light may be changed. Referring again to FIG. 1A, an example device is shown in accordance with the present invention. A few important features of the device include choice of the light source, and design of the ring resonator-based feedback loop. A description of the main points follows.

Choice of the Light Source

In principle, any gain medium for the desired color of light could be used. The gain medium may comprise at least one highly-reflective facet, which becomes one of the ends of the laser cavity (e.g., left facet/side of the optical source in FIG. 1A, the side that is not touching the photonic chip). Depending on the reflectivity of the other (e.g., front) facet (e.g., the one that touches the chip 114), the light source and the overall system will have different properties, which is one of the key designs aspects of the disclosed system.

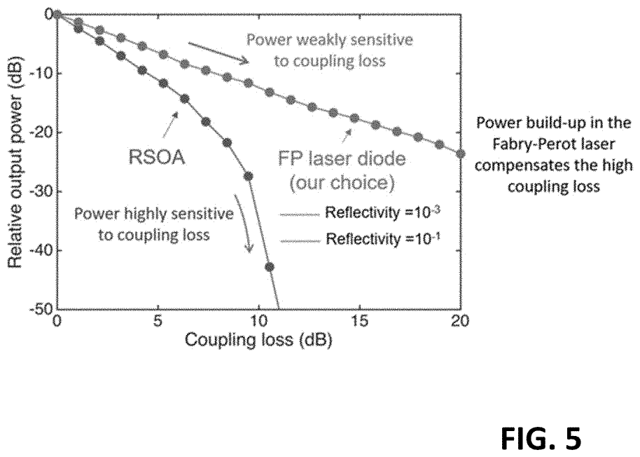

The optical source may comprise an FP laser diode. FP laser diodes have a moderate to high front-facet reflectivity (typically ≥0.1%), which is enough to form a lasing cavity between the back and front facets regardless of the existence of the photonic chip. The light coupled to the chip has many lasing wavelengths and the role of the chip is just to reflect some light of the desired wavelength. This makes the system very robust to coupling loss between the FP laser and the chip (e.g., as shown in FIG. 5). FIG. 5 is a plot showing how the relative output power of the laser (output power of the chip divided by the power emitted by the light source before the chip) changes with coupling loss. Another option of source would be a reflective semiconductor amplifier (RSOA), which has very small front-facet reflectivity (typically ≤0.01%). In this case, there are no lasing modes to start with and the laser cavity is formed by the back-facet and the ring resonator, which includes the coupling region in the middle. This makes the whole system very sensitive to the coupling loss on this interface (e.g., as shown in FIG. 5).

FIG. 5 illustrates how FP laser diodes make the system much more robust to coupling loss. FIG. 5 is a plot showing how the relative output power of the laser (e.g., output power of the chip divided by the power emitted by the light source before the chip) changes with coupling loss. In the case of FP laser diodes as sources, the total loss may be the coupling loss since the main laser cavity is not affected by it. In the case of the RSOA, the loss increases much faster since the coupling loss is part of the main lasing cavity.

Using FP laser diodes allows for good performance even at large coupling loss of 10 dB or larger, while RSOAs cannot (e.g., at 10 dB coupling loss, the relative output power is negligible in this case). This robustness of FP laser diodes becomes particularly important at visible wavelengths, where coupling losses are typically large (e.g., from 5 dB to 10 dB is a good representative range) and is a key feature that makes our invention successful. The disclosed approach using FP laser diodes is also more robust to unwanted reflections than other approaches (e.g., using RSOAs).

With the disclosed techniques, lasers covering wavelengths from deep blue (around 450 nm) to near-IR (785 nm) can safely be made. This is demonstrated experimentally. For each desired wavelength a FP laser diode of that color may be used. Each laser diode can typically cover a range of 4 to 6 nm (e.g., even more in the near-IR range). Using the present techniques, a range of up to 12 nm was demonstrated. It is completely reasonable to expect that the disclosed devices can cover longer wavelengths in the near-IR (e.g., up to around 1 μm) and shorter wavelengths in the deep visible (e.g., down to 405 nm, which is the color violet).

Design of the Ring Resonator-Based Feedback Loop

FIG. 6 shows an example resonator. The example resonator may be at least a part of a feedback loop. The resonator (e.g., feedback loop) may have and/or be associated with any combination of the following features. The resonator (e.g., feedback loop) may have a narrower width at the two coupling regions (top and bottom). The resonator may be configured (e.g., dimensioned) such that only a single optical mode of exists and/or is excited at the coupling region. This may provide clean feedback to the laser to avoid mode-hopping. The excitation of multiple modes could give feedback to unwanted modes of the FP laser, causing competition and leading to mode-hopping.

The waveguide and/or resonator may be configured with strong coupling between the waveguides and the ring resonator across the whole visible spectrum. This means that when aligned to one of the lasing modes the resonator efficiently drops light to the feedback loop and then reflects light back to the FP laser. This configuration may ensure that the reflection from the resonator is stronger than any unwanted reflection, which makes the laser stable and mode-hop free.

At the mid-point (e.g., point of widest with) of the disclosed resonator, the following conditions may be implemented. The scattering loss may be reduced by minimizing the overlap of the optical mode with the imperfect sidewalls. This increases the quality factor of the ring, which is useful for narrow linewidth lasing (e.g., lower loss means narrower linewidth). The resonator may have a gradual tapering that maintains the light in the single optical mode excited at the coupling region while transitioning to the wide width.

The size of the ring may be selected with a small enough radius (or equivalently small circumference) to avoid mode-hopping. The small size may cause the free-spectral range (FSR, e.g., how far in wavelength the adjacent resonances of the ring are from each other) of the ring to be large, so that only one resonance aligns with a lasing mode of the FP laser and only this specific wavelength is fed-back. If the FSR was small, multiple resonances could align to different lasing modes, causing competition and mode-hopping between them.

In some implementations, the specific values of the relevant design quantities (e.g., narrowest width, widest width and radius, thickness) can be optimized for each desired color of light. In other implementations, the same design values may be used for all the colors in our demonstration. Reasonable ranges for the disclosed device platform can be as follows. The narrowest width of the resonator may be in a range from about 300 nm to about 500 nm. The exact desirable range may depend on the wavelength in order to ensure single-mode operation and strong coupling to the waveguides. The widest width of the resonator may be in a range of about 700 nm to about 2500 nm. The exact desirable range may depend on the wavelength, radius, and/or desired loss (e.g., for a given wavelength, wider width may provide lower loss, but may require a larger radius for the tapering between widths to be slow enough).

The radius of the resonator may be in a range of about 5 μm to about 40 μm. The exact desirable range may depend on the FSR of the FP laser diode used and desired linewidth (e.g., smaller radius increases the scattering loss). The thickness (e.g., silicon nitride thickness) of the resonator may be in a range of about 100 nm to about 450 nm. The exact desirable range may depend on the desired wavelengths.

A variety of features may be used to implement the feedback loop. The feedback loop may comprise 1×2 multimode-interferometers (MMIs). In another implementation, the 1×2 multimode-interferometers (MMIs) could be replaced by a Y splitter that would work for any color of light. The bends of the feedback loop can be made shorter as compared to the disclosed example device, which should also improve the performance of the lasers. The feedback loop could be eliminated if the resonator itself is used to provide feedback. The resonator-only implementation can be achieved non-deterministically by random sidewalls scattering or deterministically by adding scatterers on the ring designed to reflect the desired color of light. Overall, the ring resonator geometry and feedback loop may be optimized for each desired wavelength. The geometry of the example devices may be modified from to meet design specifications. The values and dimensions chosen for purposes of illustration are values that provide a good compromise for all the colors of light, but different values may be better optimized for specific wavelengths.

Even though silicon nitride is mentioned throughout the disclosure, other material platforms could be used. The disclosed device (e.g., the resonator, waveguides, feedback loop) is not limited to silicon nitride. Any other material that is optically transparent at visible wavelengths could be used, such as lithium niobate, aluminum nitride, aluminum oxide, titanium oxide, magnesium fluoride, etc. The microheaters as phase shifters could be replaced by other kinds of phase shifters in other material platforms, such as electro-optic phase shifters in lithium niobate.

The disclosed techniques improve over other approaches, such as Microtoroid-based lasers or RSOA plus low-confinement photonic chips. Microtoroid-based lasers are not chip-scale, rely on external free-space components, have little tunability, are hard to tune (require bulky piezoelectric actuators and/or thermoelectric cooler elements), and have complex packaging. RSOA plus low-confinement photonic chip are very sensitive to coupling loss and unwanted reflections (e.g., which limits scalability to higher optical powers and to shorter wavelengths) and large footprint (chip has scale of centimeters). Only a red laser has been demonstrated with this platform, not any other color.

A summary of the specifications of example chip-scale visible lasers from deep blue to near-IR is shown below in Table 1.

TABLE 1

| | | | | | | Fiber- |
|---|---|---|---|---|---|---|
| | Coarse | Fine | Measured | Estimated | | coupled |
| Wavelength | tuning | tuning | linewidth | Linewidth | SMSR | power |
| (nm) | (GHz) | (GHz) | (khz) | (khz) | (db) | (mw) |
| 785 | 12.00 | 33.9 | ≤(0.6 ± 0.2)* | <0.9 | ≥35 | 10.00 |
| 660 | 4.24 | 11.3 | — | <5.0 | ≥35 | 4.42 |
| 520 | 4.47 | 8.2 | — | <0.2 | ≥35 | 9.89 |
| 488 | 5.62 | 3.7 | ≤(8 ± 2)* | <1.2 | ≥35 | 1.75 |
| 450 | 4.49 | 2.0 | — | <3.4 | ≥35 | 1.74 |

The disclosure may include one or more or a combination of any of the following aspects.

Aspect 1. A device comprising, consisting of, or consisting essentially of one or more of: an optical source configured to output light; a waveguide optically coupled to the optical source and configured to carry the light; a feedback portion configured to reflect the light back to the optical source via the waveguide, wherein the feedback portion comprises a microresonator optically coupled to the waveguide; and one or more tuning elements configured to tune one or more of the microresonator or the waveguide to cause constructive interference between the reflected light and light of the optical source, resulting in optical emission of both the reflected light and the light of the optical source from an end of the waveguide.

Aspect 2. The device of Aspect 1, wherein the feedback portion comprises a feedback loop optically coupled to the microresonator and configured to receive light from the microresonator and provide the reflected light back to the microresonator.

Aspect 3. The device of Aspect 2, wherein the feedback loop comprises one or more of a multimode-interferometer or Y splitter.

Aspect 4. The device of any one of Aspects 2-3, wherein the feedback loop is optically coupled to a side of the microresonator opposite of a side of the microresonator coupled to the waveguide.

Aspect 5. The device of any one of Aspects 1-4, wherein one or more of the optical source, the waveguide, the feedback portion, or the one or more tuning elements comprise a light emitting element of a plurality of light emitting elements, wherein each of the plurality of light emitting elements are configured to output a different wavelength of light.

Aspect 6. The device of Aspect 5, wherein each of the plurality of light emitting elements are disposed on a single integrated chip.

Aspect 7. The device of any one of Aspects 5-6, wherein the plurality of light emitting elements together configure the device to output light along a full range of wavelengths from about 400 nm to about 800 nm.

Aspect 8. The device of any one of Aspects 1-7, wherein the optical source comprises a Fabry-Perot laser diode.

Aspect 9. The device of any one of Aspects 1-8, wherein the optical source emits laser light.

Aspect 10. The device of any one of Aspects 1-9, wherein the optical source is configured to output one or more of visible light, near infrared light, or light in the range of about 400 nm to about 800 nm.

Aspect 11. The device of any one of Aspects 1-10, further comprising an integrated chip comprising one or more of the optical source, the waveguide, the microresonator, or the one or more tuning elements.

Aspect 12. The device of Aspect 11, further comprising an additional chip comprising the optical source and coupled to the integrated chip.

Aspect 13. The device of any one of Aspect 11-12, wherein the integrated chip comprises the optical source.

Aspect 14. The device of any one of Aspects 1-13, wherein the microresonator has a cross-sectional width that tapers along a circumference of microresonator such that a width of the microresonator is narrower at a coupling region of the microresonator and the waveguide than at a mid point of the microresonator.

Aspect 15. The device of any one of Aspects 1-14, wherein the microresonator has a first cross-sectional width at a coupling region of the microresonator and the waveguide and a second cross-sectional width at a mid-point of the microresonator, wherein the first cross-sectional width allows only carries mode of light and the second cross-sectional width has a decreased scattering loss in comparison the first cross-sectional width.

Aspect 16. The device of any one of Aspects 1-15, wherein the one or more tuning elements comprise a first tuning element disposed on at least a portion of the microresonator, wherein the first tuning element is configured to tune the microresonator to align its resonance to a wavelength of the optical source.

Aspect 17. The device of any one of Aspects 1-16, wherein the one or more tuning elements comprise a second tuning element disposed on at least a portion of the waveguide between the optical source and the microresonator, wherein the second tuning element is configured to adjust a phase of the reflected light to interfere constructively with the light of the optical source.

Aspect 18. The device of any one of Aspects 1-18, wherein the one or more tuning elements comprise one or more of electro-optic modulators (e.g., based on lithium niobate) or heaters.

Aspect 19. A system comprising, consisting of, or consisting essentially of: one or more devices according to any one of Aspects 1-18; and a computing device configured to control the one or more devices to output light.

Aspect 20. A method comprising, consisting of, or consisting essentially of: causing an optical source to output light; supplying, via a waveguide optically coupled to the optical source, the light to a feedback portion; reflecting, via the feedback portion, the light back to the optical source via the waveguide, wherein the feedback portion comprises a microresonator optically coupled to the waveguide; and tuning one or more tuning elements configured to tune one or more of the microresonator or the waveguide to cause constructive interference between the reflected light and light of the optical source, resulting in optical emission of both the reflected light and the light of the optical source from an end of the waveguide.

Aspect 21. The method of Aspect 20, wherein one or more of the optical source, the waveguide, feedback portion, and the one or more tuning elements comprise a light emitting element of a plurality of light emitting elements, wherein each of the plurality of light emitting elements are configured to output a different wavelength of light.

Aspect 22. The method of Aspect 21, further comprising, consisting of, or consisting essentially of: receiving a control indication; determining, based on the control indication, one or more wavelengths or wavelength ranges; and causing, based on the one or more wavelengths or wavelength ranges, activation of one or more of the light emitting elements.

Aspect 23. The method of Aspect 22, wherein the control indication comprises one or more of a control signal, control message, triggering event, or a combination thereof.

Aspect 24. The method of any one of Aspects 22-23, wherein the control indication is received, via a network, from one or more of a computing device, server, mobile device, or client device.

Aspect 25. The method of any one of Aspects 22-24, wherein the control indication is received based on user input via a user interface.

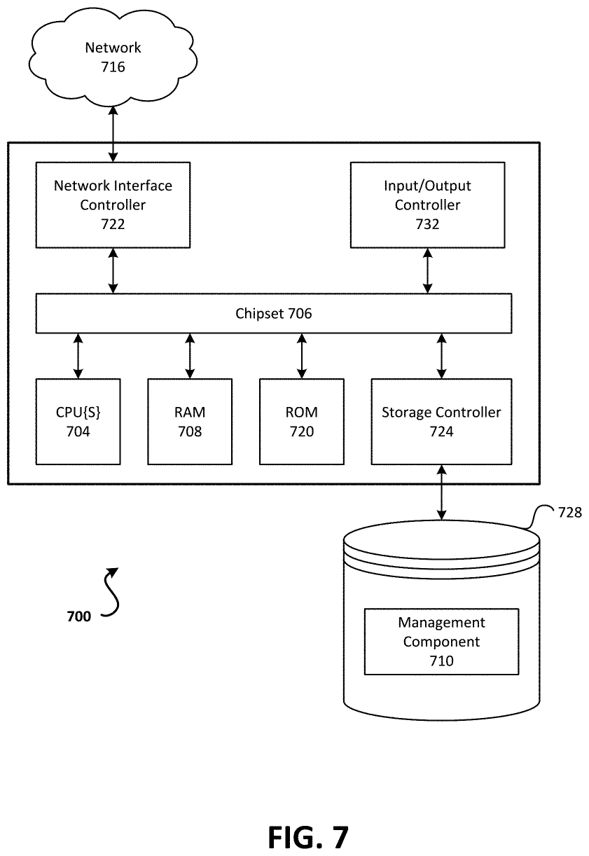

FIG. 7 depicts a computing device that may be used in various aspects, such as in the devices and methods described herein to generate light. The computing device may be an controller, microcontroller, processor and/or the like for controlling the devices and systems disclosed here. The computer architecture shown in FIG. 7 may be implemented in a conventional server computer, workstation, desktop computer, laptop, tablet, network appliance, PDA, e-reader, digital cellular phone, or other computing node, and may be utilized to execute any aspects of the computers described herein, such as to implement the methods described in relation to generation of light.

The computing device 700 may include a baseboard, or “motherboard,” which is a printed circuit board to which a multitude of components or devices may be connected by way of a system bus or other electrical communication paths. One or more central processing units (CPUs) 704 may operate in conjunction with a chipset 706. The CPU(s) 704 may be standard programmable processors that perform arithmetic and logical operations necessary for the operation of the computing device 700.

The CPU(s) 704 may perform the necessary operations by transitioning from one discrete physical state to the next through the manipulation of switching elements that differentiate between and change these states. Switching elements may generally include electronic circuits that maintain one of two binary states, such as flip-flops, and electronic circuits that provide an output state based on the logical combination of the states of one or more other switching elements, such as logic gates. These basic switching elements may be combined to create more complex logic circuits including registers, adders-subtractors, arithmetic logic units, floating-point units, and the like.

The CPU(s) 704 may be augmented with or replaced by other processing units, such as GPU(s) 705. The GPU(s) 705 may comprise processing units specialized for but not necessarily limited to highly parallel computations, such as graphics and other visualization-related processing.

A chipset 706 may provide an interface between the CPU(s) 704 and the remainder of the components and devices on the baseboard. The chipset 706 may provide an interface to a random access memory (RAM) 708 used as the main memory in the computing device 700. The chipset 706 may further provide an interface to a computer-readable storage medium, such as a read-only memory (ROM) 720 or non-volatile RAM (NVRAM) (not shown), for storing basic routines that may help to start up the computing device 700 and to transfer information between the various components and devices. ROM 720 or NVRAM may also store other software components necessary for the operation of the computing device 700 in accordance with the aspects described herein.

The computing device 700 may operate in a networked environment using logical connections to remote computing nodes and computer systems through local area network (LAN) 716. The chipset 706 may include functionality for providing network connectivity through a network interface controller (NIC) 722, such as a gigabit Ethernet adapter. A NIC 722 may be capable of connecting the computing device 700 to other computing nodes over a network 716. It should be appreciated that multiple NICs 722 may be present in the computing device 700, connecting the computing device to other types of networks and remote computer systems.

The computing device 700 may be connected to a mass storage device 728 that provides non-volatile storage for the computer. The mass storage device 728 may store system programs, application programs, other program modules, and data, which have been described in greater detail herein. The mass storage device 728 may be connected to the computing device 700 through a storage controller 724 connected to the chipset 706. The mass storage device 728 may consist of one or more physical storage units. A storage controller 724 may interface with the physical storage units through a serial attached SCSI (SAS) interface, a serial advanced technology attachment (SATA) interface, a fiber channel (FC) interface, or other type of interface for physically connecting and transferring data between computers and physical storage units.

The computing device 700 may store data on a mass storage device 728 by transforming the physical state of the physical storage units to reflect the information being stored. The specific transformation of a physical state may depend on various factors and on different implementations of this description. Examples of such factors may include, but are not limited to, the technology used to implement the physical storage units and whether the mass storage device 728 is characterized as primary or secondary storage and the like.

For example, the computing device 700 may store information to the mass storage device 728 by issuing instructions through a storage controller 724 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing device 700 may further read information from the mass storage device 728 by detecting the physical states or characteristics of one or more particular locations within the physical storage units.

In addition to the mass storage device 728 described above, the computing device 700 may have access to other computer-readable storage media to store and retrieve information, such as program modules, data structures, or other data. It should be appreciated by those skilled in the art that computer-readable storage media may be any available media that provides for the storage of non-transitory data and that may be accessed by the computing device 700.

By way of example and not limitation, computer-readable storage media may include volatile and non-volatile, transitory computer-readable storage media and non-transitory computer-readable storage media, and removable and non-removable media implemented in any method or technology. Computer-readable storage media includes, but is not limited to, RAM, ROM, erasable programmable ROM (“EPROM”), electrically erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage, other magnetic storage devices, or any other medium that may be used to store the desired information in a non-transitory fashion.

A mass storage device, such as the mass storage device 728 depicted in FIG. 7, may store an operating system utilized to control the operation of the computing device 700. The operating system may comprise a version of the LINUX operating system. The operating system may comprise a version of the WINDOWS SERVER operating system from the MICROSOFT Corporation. According to further aspects, the operating system may comprise a version of the UNIX operating system. Various mobile phone operating systems, such as IOS and ANDROID, may also be utilized. It should be appreciated that other operating systems may also be utilized. The mass storage device 728 may store other system or application programs and data utilized by the computing device 700.

The mass storage device 728 or other computer-readable storage media may also be encoded with computer-executable instructions, which, when loaded into the computing device 700, transforms the computing device from a general-purpose computing system into a special-purpose computer capable of implementing the aspects described herein. These computer-executable instructions transform the computing device 700 by specifying how the CPU(s) 704 transition between states, as described above. The computing device 700 may have access to computer-readable storage media storing computer-executable instructions, which, when executed by the computing device 700, may perform the methods described in relation to generation of light.

A computing device, such as the computing device 700 depicted in FIG. 7, may also include an input/output controller 732 for receiving and processing input from a number of input devices, such as a keyboard, a mouse, a touchpad, a touch screen, an electronic stylus, or other type of input device. Similarly, an input/output controller 732 may provide output to a display, such as a computer monitor, a flat-panel display, a digital projector, a printer, a plotter, or other type of output device. It will be appreciated that the computing device 700 may not include all of the components shown in FIG. 7, may include other components that are not explicitly shown in FIG. 7, or may utilize an architecture completely different than that shown in FIG. 7.

As described herein, a computing device may be a physical computing device, such as the computing device 700 of FIG. 7. A computing node may also include a virtual machine host process and one or more virtual machine instances. Computer-executable instructions may be executed by the physical hardware of a computing device indirectly through interpretation and/or execution of instructions stored and executed in the context of a virtual machine.

It is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Components are described that may be used to perform the described methods and systems. When combinations, subsets, interactions, groups, etc., of these components are described, it is understood that while specific references to each of the various individual and collective combinations and permutations of these may not be explicitly described, each is specifically contemplated and described herein, for all methods and systems. This applies to all aspects of this application including, but not limited to, operations in described methods. Thus, if there are a variety of additional operations that may be performed it is understood that each of these additional operations may be performed with any specific embodiment or combination of embodiments of the described methods.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described herein with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, may be implemented by computer program instructions. These computer program instructions may be loaded on a general-purpose computer, special-purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto may be performed in other sequences that are appropriate. For example, described blocks or states may be performed in an order other than that specifically described, or multiple blocks or states may be combined in a single block or state. The example blocks or states may be performed in serial, in parallel, or in some other manner. Blocks or states may be added to or removed from the described example embodiments. The example systems and components described herein may be configured differently than described. For example, elements may be added to, removed from, or rearranged compared to the described example embodiments.

It will also be appreciated that various items are illustrated as being stored in memory or on storage while being used, and that these items or portions thereof may be transferred between memory and other storage devices for purposes of memory management and data integrity. Alternatively, in other embodiments, some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

While the methods and systems have been described in connection with preferred embodiments and specific examples, it is not intended that the scope be limited to the particular embodiments set forth, as the embodiments herein are intended in all respects to be illustrative rather than restrictive.

It will be apparent to those skilled in the art that various modifications and variations may be made without departing from the scope or spirit of the present disclosure. Other embodiments will be apparent to those skilled in the art from consideration of the specification and practices described herein. It is intended that the specification and example figures be considered as exemplary only, with a true scope and spirit being indicated by the following claims.

What is claimed:

1. A device comprising:
an optical source configured to output light;
a waveguide optically coupled to the optical source and configured to carry the light;
a feedback portion configured to reflect the light back to the optical source via the waveguide, wherein the feedback portion comprises a microresonator optically coupled to the waveguide; and
one or more tuning elements configured to tune one or more of the microresonator or the waveguide to cause constructive interference between the reflected light and light of the optical source, resulting in optical emission of both the reflected light and the light of the optical source from an end of the waveguide.

2. The device of claim 1, wherein the feedback portion comprises a feedback loop optically coupled to the microresonator and configured to receive light from the microresonator and provide the reflected light back to the microresonator.

3. The device of claim 2, wherein the feedback loop comprises one or more of a multimode-interferometer or Y splitter.

4. The device of claim 2, wherein the feedback loop is optically coupled to a side of the microresonator opposite of a side of the microresonator coupled to the waveguide.

5. The device of claim 1, wherein one or more of the optical source, the waveguide, the feedback portion, or the one or more tuning elements comprise a light emitting element of a plurality of light emitting elements, wherein each of the plurality of light emitting elements are configured to output a different wavelength of light.

6. The device of claim 5, wherein each of the plurality of light emitting elements are disposed on a single integrated chip.

7. The device of claim 5, wherein the plurality of light emitting elements together configure the device to output light along a full range of wavelengths from about 400 nm to about 800 nm.

8. The device of claim 1, wherein the optical source comprises a Fabry-Perot laser diode.

9. The device of claim 1, wherein the optical source emits laser light.

10. The device of claim 1, wherein the optical source is configured to output one or more of visible light, near infrared light, or light in the range of about 400 nm to about 800 nm.

11. The device of claim 1, further comprising an integrated chip comprising one or more of the optical source, the waveguide, the microresonator, or the one or more tuning elements.

12. The device of claim 11, further comprising an additional chip comprising the optical source and coupled to the integrated chip.

13. The device of claim 11, wherein the integrated chip comprises the optical source.

14. The device of claim 1, wherein the microresonator has a cross-sectional width that tapers along a circumference of microresonator such that a width of the microresonator is narrower at a coupling region of the microresonator and the waveguide than at a mid-point of the microresonator.

15. The device of claim 1, wherein the microresonator has a first cross-sectional width at a coupling region of the microresonator and the waveguide and a second cross-sectional width at a mid-point of the microresonator, wherein the first cross-sectional width allows only a single mode of light and the second cross-sectional width has a decreased scattering loss in comparison the first cross-sectional width.

16. The device of claim 1, wherein the one or more tuning elements comprise a first tuning element disposed on at least a portion of the microresonator, wherein the first tuning element is configured to tune the microresonator to align its resonance to a wavelength of the optical source.

17. The device of claim 1, wherein the one or more tuning elements comprise a second tuning element disposed on at least a portion of the waveguide between the optical source and the microresonator, wherein the second tuning element is configured to adjust a phase of the reflected light to interfere constructively with the light of the optical source.

18. The device of claim 1, wherein the one or more tuning elements comprise one or more of electro-optic modulators or heaters.

19. A system comprising:
one or more devices comprising:
an optical source configured to output light;
a waveguide optically coupled to the optical source and configured to carry the light;
a feedback portion configured to reflect the light back to the optical source via the waveguide, wherein the feedback portion comprises a microresonator optically coupled to the waveguide; and
one or more tuning elements configured to tune one or more of the microresonator or the waveguide to cause constructive interference between the reflected light and light of the optical source, resulting in optical emission of both the reflected light and the light of the optical source from an end of the waveguide; and
a computing device configured to control the one or more devices to output light.

20. A method comprising:
causing an optical source to output light;
supplying, via a waveguide optically coupled to the optical source, the light to a feedback portion;
reflecting, via the feedback portion, the light back to the optical source via the waveguide, wherein the feedback portion comprises a microresonator optically coupled to the waveguide; and
tuning one or more tuning elements configured to tune one or more of the microresonator or the waveguide to cause constructive interference between the reflected light and light of the optical source, resulting in optical emission of both the reflected light and the light of the optical source from an end of the waveguide.
